(19) United States
(12) Patent Application Publication
(10) Pub. No.: US 2012/0016741 A1
(43) Pub. Date: Jan. 19, 2012

(54) TARGETING CONTENT WITHOUT KEYWORDS

(75) Inventors: Lawrence J. Brunsman, Mountain View, CA (US); Sriram Rajaraman, San Jose, CA (US); Priyendra Deshwal, Mountain View, CA (US); Matthew D. Wytock, San Jose, CA (US); Sheridan Kates, San Francisco, CA (US)

(73) Assignee: Google Inc., Mountain View, CA (US)

(21) Appl. No.: 12/838,948

(22) Filed: Jul. 19, 2010

(51) Int. Cl. G06Q 30/00; G06F 17/30

(52) U.S. Cl. 705/14.49; 707/741; 707/749; 707/E17.084; 707/E17.11

(57) ABSTRACT

Methods, systems, and apparatus, including computer programs encoded on computer storage media, that are operable to index a plurality of commercial landing web pages in a database using queries previously resolved to the commercial landing pages where each entry in the database includes at least one query and a pointer to a commercial landing web page. A query can be received. The query can be processed by one or more processors including identifying a relevant commercial landing web page using the query. An advertisement creative can be generated from the relevant commercial landing web page.

### BACKGROUND

This specification relates to providing information relevant to user requests.

Internet search engines identify resources, e.g., Web pages, images, text documents, and multimedia content, in response to queries submitted by users and present information about the resources in a manner that is useful to the users.

A conventional query processing service can include an input control that allows the user to provide a textual input in the form of a search query. In some conventional services, advertisements (ads) or other content can be provided to a user system for presentation in response to a received textual input provided by the user. In some instances, advertisements can be identified based on matches between textual input provided by a user and keywords associated with one or more advertisements.

Publishers can include content provided by third party content providers in publications under the publisher's control. At the time for publication (e.g., rendering), a request can be made to the third party content provider to supply the additional content. For example, an on-line newspaper publisher can include one or more advertisements with their publication. Each advertisement (ad) includes a creative that is typically provided by the advertiser. As another example, a web site includes advertisement slots in one or more web pages of the web site. The advertisement slots may be purchased by advertisers, and an advertisement server system provides the advertisements for display on behalf of the advertisers.

### SUMMARY

This specification describes methods, systems, and apparatus including computer program products for presenting content in response to a user request.

In general, one aspect of the subject matter described in this specification can be embodied in computer-implemented methods that include indexing a plurality of commercial landing web pages in a database using queries previously resolved to the commercial landing pages where each entry in the database includes at least one query and a pointer to a commercial landing web page. A query can be received. The query can be processed by one or more processors including identifying a relevant commercial landing web page using the query. An advertisement creative can be generated from the relevant commercial landing web page.

These and other embodiments can each optionally include one or more of the following features. Each entry in the database can include metadata for generating the advertisement creative. The metadata can include a title from an associated commercial landing web page. The metadata can include a title derived from large font words included in an associated commercial landing web page. The metadata can include a title derived from anchors associated with the commercial landing web page. The metadata can include segmentation data that identifies n-grams in a title associated with the commercial landing web page. The metadata can include a destination uniform resource locator (URL) associated with the commercial landing web page. Each entry in the database can include a creative previously generated from an associated commercial landing web page.

The pointer to a commercial landing page can be of the form of metadata describing content from the commercial landing web page which is used to generate the advertisement creative. The pointer to a commercial landing page can be of the form of a creative previously generated from an associated commercial landing web page. Indexing can include mapping one or more queries to a commercial landing web page. Mapping can include mapping plural queries to one commercial landing page. Generating an advertisement creative can include extracting at least a portion of the content from the relevant commercial landing web page. Generating an advertisement creative can include extracting a title from the relevant commercial landing web page.

In general, another aspect of the subject matter described in this specification can be embodied in computer-implemented methods that include mapping commercial landing web pages to one or more queries, each query being historically resolved at least once to a given commercial landing web page. A new query can be received. The new query can be processed, by one or more processors, including comparing the new query to the queries in the mapping to locate one or more relevant commercial landing web pages. The relevant commercial landing web pages can be ranked. One or more ads associated with one or more highest ranking relevant commercial landing pages can be provided in response to the new query.

In general, another aspect of the subject matter described in this specification can be embodied in computer-implemented methods that include identifying a plurality of commercial landing web pages that are not being targeted by an advertisement serving system. One or more queries can be mapped to each commercial landing web page. Relevant advertisements associated with the commercial landing web pages can be served in response to received queries. The serving can include not requiring a sponsor of a given commercial landing web page to provide keywords or a creative for the served advertisements where serving includes automatically generating an advertisement creative for a given commercial landing web page using content included in the commercial landing web page.

Particular embodiments of the subject matter described in this specification can be implemented so as to realize none, one or more of the following advantages. Commercial landing pages can be identified as being relevant to a user query or other ad request without requiring an advertiser to provide keywords or an advertisement creative in association with the commercial landing page. Ad creatives can be generated from information derived from commercial landing pages. Ad creatives can be displayed along side search results or other content requested by an end user without matching a user query or other ad request to keywords provided by an advertiser.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for targeting ads without requiring an advertiser to supply keywords.

FIG. 2 illustrates an example method for identifying commercial landing pages in response to a query without requiring the advertiser to provide keywords.

FIG. 3 illustrates an example architecture for a query processing service system.

FIG. 4 illustrates an example method for selecting relevant commercial landing pages without requiring the advertiser to provide keywords.

FIG. 5 illustrates an example method for serving relevant advertisements associated with the commercial landing web pages in response to received queries.

FIG. 6 illustrates an example hardware configuration.

Like reference numbers and designations in the various drawings indicate like elements.

### DETAILED DESCRIPTION

The following disclosure describes systems, methods, and apparatus for providing advertisements derived from web pages (e.g., commercial landing pages) where the sponsor of the web page is not required to provide one or more of keywords and/or creatives. The advertisements derived from web pages can be served in response to a user submitted query and be displayed along side search results for the user submitted query. Alternatively, the advertisements can be provided in response to a request for advertisements and published along with other content of a publisher. In some implementations, the web pages comprise commercial landing pages that provide information on purchasable products or services, or web pages that facilitate the purchasing of products or services. For example, a commercial landing page can be a page describing a particular brand of golf shoe. As another example, a commercial landing page can be a web page that allows a user to purchase flowers.

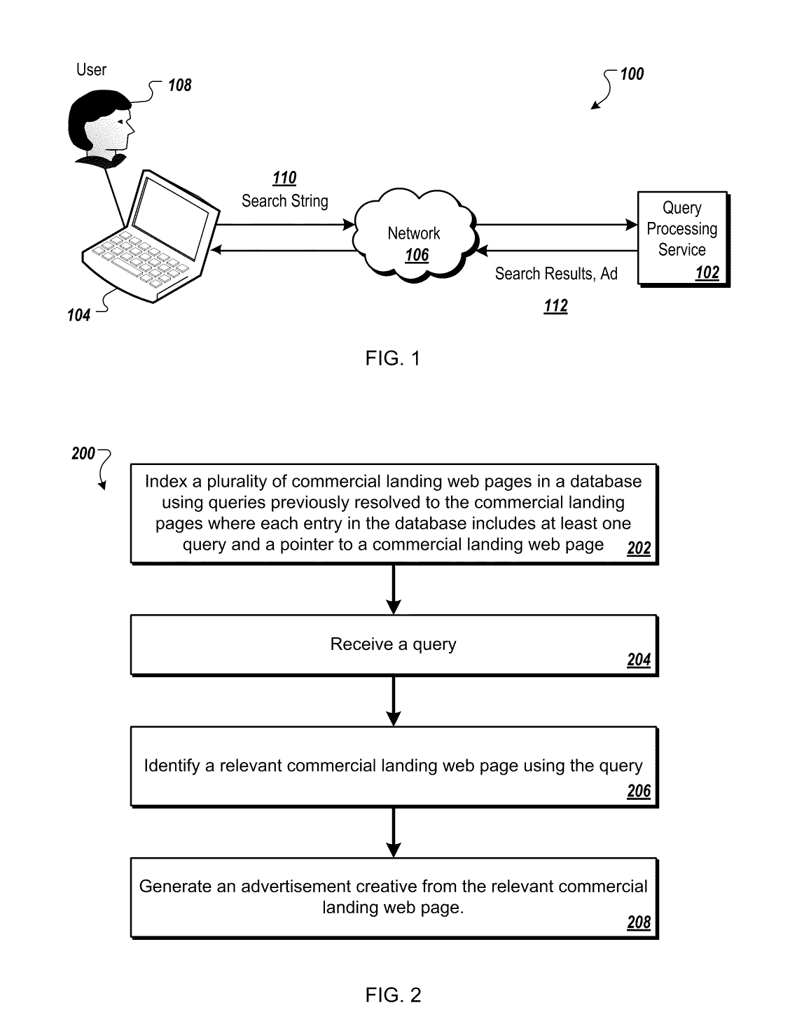

FIG. 1 illustrates an example system 100 for determining and providing query results and/or associated content in response to user input. The associated content can be of the form of Web content and/or Web-based advertisements (or “ads”) that are associated with the query. Non-ad Web content can include links to web sites or other content, news, weather, images, video, auctions, related information, answers to questions, or other information. The identification of associated ad content is described in greater detail below.

The system 100 includes a query processing service 102 that is communicatively coupled to a client device 104 via a network 106. The query processing service 102 can be any content provider or search engine provider, such as Google Search, that provides content and/or ads in response to user queries, inputs or other selections. Other forms of service are possible. The query processing service 102 can be accessible from applications running on the client device 104, such as coupled to (or in communication with) the user's Web browser, any search input dialog, and so forth. The information returned by the query processing service 102 can include search results for a user entered search query, and content (e.g., advertisements) that may correspond to the search results. In some implementations, the system 100 can be used to provide search results and ad content in response to input that the user has provided in applications other than Web browsers, such as input boxes or other controls used in support of other applications (e.g., forms used in online shopping applications). In some implementations, the system 100 can be used to provide relevant ads in response to processing a query that is of the form of an ad request.

In some implementations, system 100 receives user input, typically in a control (e.g., a search query box) that is presented on a user interface associated with the client device 104. The control can be of the form of a textual input box or other input mechanism that is configured to receive user input. In some implementations, the user input is of the form of textual characters, tokens or other input that make up a request. The user input can include numbers, letters, symbols, or other identifiers. The request can be of the form of a search query. The client device 104 can provide the user input, by way of the network 106, to the query processing service 102. In return, in some implementations, the query processing service 102 can provide search results along with other content back to the client device 104. While the system shown includes a remote query processing service 102 that is linked by way of the network 106, portions of the query processing service 102 can be included in the client device 104. While the system is described with reference to a query processing service, other forms of user requests and other services can be provided in support of a given user input.

In some implementations, additional content that is provided by the query processing service 102 along with search results includes one or more ads for presentation (e.g., along with the search results or with other publisher content). The ads provided by the query processing service 102 can link to web pages associated with one or more advertisers. In some implementations, the web pages are commercial landing pages. The commercial landing pages can be web pages that provide information on purchasable products or services offered by advertisers, or web pages that facilitate the purchasing of products or services offered by advertisers. In some implementations, one or more of the ads provided by the query processing service 102 are associated with keywords. The ads can be identified as being relevant to a user entered query based on matches between the query and the keywords associated with the ads. The keywords can be provided by the advertiser or developed by the query processing service 102 as described in greater detail below.

In some implementations, one or more of the ads provided by the query processing service 102 are not associated with keywords that have been provided by a respective advertiser. For example, a particular advertiser may not possess the resources to provide keywords in association with ads or commercial landing pages. In some implementations, prior search queries that were resolved to a given commercial landing page can be used along with one or more terms in a received query to identify commercial landing pages that are relevant to the received query. In some implementations, ads associated with the identified commercial landing pages are provided by the query processing service 102. In some implementations, ad creatives can be automatically generated based on information extracted from the commercial landing pages. The automatically generated creatives can then be provided by the query processing service 102 in response to user entered queries.

In an example scenario of the system 100, the user 108 can enter a search string 110 using an input device of the client device 104. The client device 104 transmits the search string 110 to the query processing service 102 through the network 106. The query processing service 102 uses the received search string 110 to identify one or more commercial landing pages that are relevant to the search string 110. In some implementations, the query processing service 102 can identify relevant commercial landing pages by performing a search of commercial landing pages associated with advertisers that have contracted with the query processing service 102 to provide ads in association with commercial landing pages on behalf of the advertisers. For example, a number of advertisers can identify web sites or web pages for which advertisements are to be supplied by the query processing service 102 without providing keywords for the commercial landing pages. The query processing service 102 can identify commercial landing pages included in the indicated web sites and web pages. In some implementations, an advertiser can indicate a web site that includes commercial landing pages for which ads are to be supplied, and further indicate web pages included within the web site for which ads are not to be supplied. For example, one or more web pages included in a web site may not include any information for purchasable products or services.

In some implementations, the query processing service 102 or an associated system can conduct a web crawl of identified commercial landing pages associated with advertisers in order to discover the commercial landing pages. Discovered commercial landing pages can be indexed by prior search queries that were resolved to a given page. When a new search string 110 is received from the client device 104, the query processing service 102 can search the indexed web data to identify one or more commercial landing pages that are relevant to the search string 110. For example, one or more terms of the search string can be matched to the index (e.g., compared to the prior search queries) and matching entries result in the identification of a commercial landing page that can be the subject of an advertisement. The query processing service 102 can then provide search results 112 for the search string 110 along with ads associated with the identified commercial landing pages to the client device 104 for presentation to the user 108. In some implementations, the ads associated with the commercial landing pages can be provided by advertisers. In some implementations, the query processing service 102 can generate the ads using information extracted from the commercial landing pages. For example, the query processing service 102 can extract a title or header from a commercial landing page and derive text for an ad from the extracted title or header. The query processing service 102 can additionally extract one or more images or logos from the commercial landing page to include in the provided ad. In some implementations, the provided ad includes a link back to the commercial landing page.

In some implementations, if multiple commercial landing pages identified as being relevant to the search string 110 are linked to by a single web page, the single web page can be identified as a parent page, and the parent page can be linked to by the provided ad. For example, the search string 110 can include the terms “golf shoes” and several commercial landing pages for various different models of golf shoes can be identified as being relevant to the query. The commercial landing pages can all be for golf shoes sold by the same golf shoe manufacturer. A web page of the golf shoe manufacturers web site can link to all of the identified commercial landing pages for the individual shoe models. The web page that links to the identified pages can be identified as a parent page. In some implementations, the URL or address for the parent page can be included in the provided ad rather than a link to one of the individual shoe model landing pages.

In some implementations, the query processing service 102 can access a database in order to match the search string 110 to one or more commercial landing pages. For example, prior to receiving the search string 110, the query processing service 102 can track previously received search queries and commercial landing pages that the search quires resolved to in order to create a database using queries previously resolved to the commercial landing pages. In some implementations, each query that is received by the query processing service 102 that resolves to at least one commercial landing page associated with an advertiser for which the query processing service 102 provides ads can be stored in the database. Each query stored in the database can point to the one or more commercial landing pages to which the query resolves. For example, each query/commercial landing page pair can be stored as a unique entry in the database.

In some implementations in which queries are associated with commercial landing pages in a database, upon receiving the search string 110 the query processing service 102 can access the database to determine if the search string 110 matches a query stored in the database. If the search string 110 matches a query stored in the database, the query processing service 102 can identify one or more commercial landing pages associated with the query within the database. The query processing service 102 can then provide one or more ads associated with the identified commercial landing pages to the client device 104 along with search results 112. In some implementations, the ads can be generated by the query processing service 102 using information extracted from the commercial landing pages as described above. In some implementations, the ads can include links to the identified commercial landing pages. In some implementations, a generated ad can include a link to a parent or category landing page as described above.

In some implementations, the query processing service 102 can provide information stored in a query data base to advertisers. For example, the query processing service 102 can access the database to identify queries associated with commercial landing pages for a particular advertiser. The query processing service 102 can provide the identified queries to the advertiser. In some implementations, the query processing service 102 can provide related statistical information to the advertiser. For example, the query processing service 102 can indicate a number of times that each identified query is received by the query processing service 102 for a given time period. In some implementations, the query processing service 102 can allow the advertiser to indicate queries that are not to be linked to commercial landing pages associated with the advertiser for future ad presentations. In some implementations, the advertiser can indicate commercial landing pages that are not to be included in the database. In some implementations, the advertiser can indicate specific query/commercial landing page pairs that are to be removed from the database.

In some implementations, the query processing service 102 can identify if the search string 110 is commercial in nature and only serve ads in response to the search string 110 if the search string 110 is commercial in nature. For example, if the search string 110 is “wild mountain goats” the query can be identified as not being commercial in nature, where as if the search string 110 is “digital camera,” it can be identified as being commercial in nature.

If the search string 110 is identified as being commercial in nature, relevant commercial landing pages can be identified as described above and ads associated with the commercial landing pages or generated using information derived from the commercial landing pages can be provided to the client device 104 for presentation to the user 108.

In some implementations, collected advertiser or query data can be used to determine if the search string 110 is commercial in nature. For example, if the search string 110 has not be associated with an ad as a targeting keyword for the past year, the search string 110 can be identified as not being commercial in nature. As another example, if the 30 web pages identified as being most relevant to the search string 110 are not commercial in nature, the search string 110 can be identified as not being commercial in nature.

In some implementations, the query processing service 102 can identify commercial landing pages that are not associated with keywords and provide ads associated with the commercial landing pages in response to ad requests other than search strings or queries entered by end users. For example, a content provider can provide a web page to the client device 104 for display to the user 108. The web page can include advertising slots for displaying one or more ads provided by an ad serving system. In some implementations, the query processing service 102 can serve as the ad serving system.

The ad slots can be designated portions of the web page which execute code that causes an ad request to be sent to the query processing service 102. The ad request can include keywords associated with the web page that can be used to identify commercial landing pages that are relevant to the web page. The query processing service 102 can identify commercial landing pages that are relevant to the keywords using one of the above described processes. For example, the query processing service 102 can conduct a search of commercial landing pages to identify commercial landing pages that are relevant to the keywords associated with the web page. As another example, the query processing service 102 can access a database that includes pointers from queries to commercial landing pages. The keywords associated with the web page can be matched to queries in the database and commercial landing pages pointed to by the queries can be identified. Ads associated with the identified commercial landing pages can then be provided to the client device 104.

Referring now to FIG. 2, a method 200 is shown for identifying commercial landing pages in response to a query without requiring a sponsor of the commercial landing pages to provide keywords. The method 200 can be performed by a system, such as the system 100 shown in FIG. 1. At stage 202, a plurality of commercial landing web pages are indexed in a database using queries previously resolved to the commercial landing pages where each entry in the database includes at least one query and a pointer to a commercial landing web page. For example, a query processing system (e.g., the query processing service 102 of FIG. 1) can identify queries that resolve to commercial landing pages and create entries in a database containing query/commercial landing page pairs. In some implementations, the commercial landing pages can be associated with advertisers that have contracted with the query processing system so that the query processing system provides ads that link to the commercial landing pages. The ads can be provided to end user systems for presentation to end users.

In some implementations, the database can include additional information. For example, the database can include links to ad creatives associated with the commercial landing pages. The ad creatives can be provided by an advertiser associated with the commercial landing pages, or generated using information extracted from the commercial landing pages. In some implementations, the database can include information extracted from the commercial landing pages that can be used to generate ad creatives.

At stage 204, a query is received. For example, referring to FIG. 1, the query processing service 102 can receive the search string 110 entered by the user 108 from the client device 104 through the network 106.

At stage 206, a relevant commercial landing web page is identified using the query. For example, the received query can be matched to query/commercial landing page pairs stored in the database. One or more commercial landing pages associated with the query in the database can be identified. As another example, a search of commercial landing pages can be conducted to identify a commercial landing page that is relevant to the received query.

At stage 208, an advertisement creative is generated from the relevant commercial landing web page. For example, a title or header for the commercial landing web page can be identified and used as text in the ad creative. As another example, one or more images can be extracted from the commercial landing web page and used to generate the ad creative. As another example, portions of the commercial landing page that are most relevant to the received query can be identified and used to generate the ad creative. In some implementations, the generated ad creative can be provided to an end user system from which the query was received for presentation to an end user.

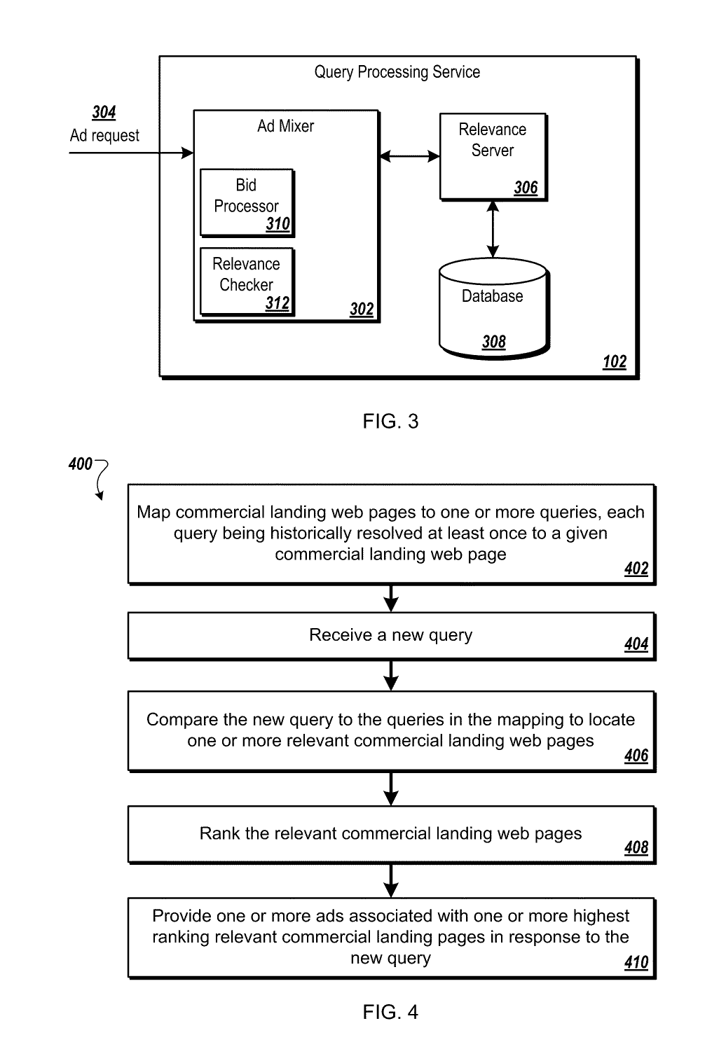

Referring now to FIG. 3, an example architecture for the query processing service system 102 is shown. The query processing service 102 can include an ad mixer 302 that receives an ad request 304. In some implementations, the ad request 304 can take the form of a user entered search query, for example, the search string 110 of FIG. 1. In some implementations, the ad request 304 can be a request initiated by ad slot code included in a web page being loaded by a web browser. The loading of the web page can cause the ad slot code to execute and initiate the ad request 304.

In some implementations, the ad mixer 302 can send the ad request 304 to a relevance server 306. The relevance server 306 can access a database 308 in order to provide one or more ad creatives in response to the ad request 304. In a first example scenario, the database 308 can include links between queries and commercial landing pages. The relevance server 306 can identify the query included in the ad request 304 within the database 308 to identify commercial landing pages that are associated with the query. In some implementations, the database 308 can be used to generate relevance scores to indicate commercial landing pages that are most relevant to the query. In some implementations, the relevance server 306 can select a set number (e.g., 3) of commercial landing pages that are identified as being most relevant to the query.

In some implementations, the relevance server 306 or an associated system can access the identified commercial landing pages and extract information from the identified commercial landing pages in order to generate ad creatives. Text, images, and other information extracted from the commercial landing pages can be used to generate the ad creatives. The ad creatives can additionally include links that link back to the commercial landing pages. In some implementations, the ad creatives can include links to parent or category landing pages that link to multiple commercial landing pages as described above.

In a second example scenario, the database 308 can include links between queries and keywordless creative data structures that includes metadata associated with a commercial landing page. A keywordless creative data structure can include, for example, information extracted from a commercial landing page that can be used to generate an ad creative for the commercial landing page. In some implementations, the information can include a title extracted from a header of a commercial landing page (e.g., as indicated by html code), prominent text identified in the commercial landing page (e.g., large font text, or bold text), and a destination URL for the commercial landing page or a parent page that links to the commercial landing page. For example, if a commercial landing page includes bolded text that reads “Brand X Basketballs,” the text can be identified as a title for the commercial landing page.

In some implementations, the keywordless creative data structure can include text extracted from anchors that link to the commercial landing page. An anchor is the text associated with a hyperlink that links to the commercial landing page. For example, a link on a first web page that links to a second web page where a user can purchase flowers can include anchor text reading “Flowers delivered to your door.” The anchor text extracted from the first web page can be stored in a keywordless creative data structure for the second web page and subsequently used to generate an ad creative for the second web page.

In some implementations, the keywordless creative data structure can include segmentation data that identifies n-grams in a title or other text associated with a commercial landing page. For example, a title for a commercial landing page can be “Surf Boards and Wet Suits by Brand XYZ.” Segmentation data stored in a keywordless creative data structure for the commercial landing page can indicate 2 word n-grams (i.e., bi-grams) identified in the title as “Surf Boards,” “Wet Suits,” and “Brand XYZ.” In some instances, identifying n-grams can include identifying two or more words that should not be split up. In some implementations, the determination can be based on how often the two or more words appear together or whether the identified words provide context. For example, the words “size thirteen” can be identified as an n-gram since the two words together provide context which would be lost if they are separated.

The database 308 can be populated with links between queries and the keywordless creative data structures when queries are identified that resolve to commercial landing pages. Each time a query is identified as resolving to a commercial landing page, the query can be associated with a keywordless creative data structure for the commercial landing page in the database 308. If a keywordless creative data structure for the commercial landing page does not already exist within the database 308, a keywordless creative data structure can be generated for the commercial landing page and stored in the database 308.

The information included in the keywordless creative data structures can be used to generate ad creatives for the associated commercial landing pages. In some implementations, the relevance server 306 can generate multiple ad creatives using a single identified keywordless creative data structure. In some implementations, the relevance server 306 can apply ranking scores to the generated ad creatives in order to identify a highest ranked ad creative for the associated commercial landing page. In some implementations, ranking scores can be at least partially based on relevance of an ad creative to the ad request 304.

In a third example scenario, the database 308 can include links between queries and ad creatives for commercial landing pages. The database 308 can be populated with query/ad creative pairs as queries are identified as resolving to commercial landing pages. In some implementations, the ad creatives can be provided by advertisers, or third party vendors on behalf of the advertisers. In some implementations, the ad creatives can be generated from information extracted from commercial landing pages as described above and stored in the database 308.

The relevance server 306 can provide generated or identified ad creatives identified as being most relevant to the ad request 304 to the ad mixer 302. In some implementations, the ad creatives provided by the relevance server 306 can include ad creatives for multiple advertisers associated with commercial landing pages that are relevant to the ad request 304. In some implementations, multiple ad creatives can be provided by the relevance server 306 for a single commercial landing page identified as being relevant to the ad request 304.

The ad mixer 302 can add the received ad creatives to a database of ad creatives that includes other ad creatives, including ad creatives that are associated with keywords. In some implementations, the ad mixer 302 can use conventional ad selection methods to identify ads to supply in response to the ad request 304. For example, the ad mixer 302 can include a bid processor 310. The bid processor 310 can process bids for advertisers associated with the keywordless ad creatives as well as ad creatives that are associated with keywords in order to select one or more ads having the highest bids to provide in response to the ad request 304.

In some implementations, if multiple ad creatives are associated with bids that are tied for the highest bid, or if a bidding process is not used to select ad creatives, the ad mixer 302 can use a relevance checker 312 to identify ads that are the most relevant to the ad request 304. In addition to identifying ad relevance based on relevance to a query included in the ad request 304, other information associated with the ad request can be used to apply relevance scores to ad creatives. Additional information can be provided by the user in an opt in system. Additional information that can be used to apply relevance scores to ad creatives can include geo-location information (e.g., location where ad request 304 originated, or location of a business associated with an ad), demographic information, or time stamp information. For example, if the query is for “restaurant” and the time of day in the area where the ad request 304 originated is 1:00 am, ads for all night diners can be identified as being most relevant to the query, whereas if the time of day is 10:00 am, ads for restaurants specializing in brunch can be identified as being most relevant. As another example, if the query is “men's shirts,” demographic information for a user associated with the ad request 304 can be used to identify clothing ads that would most appeal to people living in a same relative location as the user.

Ads identified by the bid processor 310 and/or the relevance checker 312 (e.g., as having winning bids or being the most relevant) can be supplied by the ad mixer 302 to an end user system (e.g., the client device 104 of FIG. 1) for presentation to an end user. In some implementations, the ads provided by the ad mixer 302 can include both keywordless ads generated or identified by the relevance server 306 and ads associated with keywords.

Referring now to FIG. 4, a method 400 is shown for selecting relevant commercial landing pages without requiring the sponsor of the commercial landing pages to have to provide keywords. The method 400 can be performed by a system, such as the query processing service 102 shown in FIG. 3 or the system 100 shown in FIG. 1. At stage 402, commercial landing web pages are mapped to one or more queries, each query being historically resolved at least once to a given commercial landing web page. For example, the query processing service 102 of FIG. 3 can populate the database 308 with query/commercial landing page pairs. As another example, queries stored in the database 308 can link to keywordless creative data structures associated with commercial landing pages. As yet another example, queries stored in the database 308 can be linked to ads generated from information extracted from commercial landing pages.

In some implementations, when commercial landing pages are identified as search results for user entered queries, the commercial landing pages can be mapped to the queries within a database if the queries have not already been identified as resolving to the commercial landing pages within the database. In some implementations, if an indication of a commercial landing page already exists within a database, upon identifying a query that resolves to the commercial landing page, a new mapping can be created within the database linking the identified query and the commercial landing page.

At stage 404 a new query is received. For example, referring to FIG. 3, the ad mixer 302 can receive the ad request 304 which can include a query. As another example, the relevance server 306 can receive a query from the ad mixer 302. As yet another example, referring to FIG. 1, the query processing service 102 can receive the search string 110 entered by the user 108 from the client device 104 through the network 106.

At stage 406, the new query is compared to the queries in the mapping to locate one or more relevant commercial landing web pages. For example, referring to FIG. 3, the relevance server 306 can compare a query contained in the ad request 304 to query mappings stored in the database 308. Commercial landing web pages that are associated with the received query in the database 308 can be identified. In some implementations, only commercial landing pages that are associated with a query that is an exact match for the new query are identified.

In some implementations, a user entered query can be normalized prior to matching the user entered query with queries stored in the database. In some cases, queries can be normalized according to a set of rules. For example, all plural words in a user entered query can be normalized by being converted to singular words. A query of “brand x running shoes” can be normalized, for example, by changing the work “shoes” to “shoe” to give a normalized query of “brand x running shoe.” In some cases, multiple versions of a term can be used to match a user entered query to a query in the database. For example, a user entered query of “ny pizza” can be expanded as “(ny|new york|new york city) pizza.” In this example, the query can be matched to queries in the database of “ny pizza,” “new york pizza,” or “new york city pizza.” In some cases, word stems can be removed from words. For example, a query of “swimming chicago” can be normalized to “swim chicago” by removing the stem from the word “swimming.”

In some implementations, commercial landing pages that are associated with queries having a predetermined degree of similarity to the new query can be identified. For example, if the new query shares two or more words with a query in the database 308, a commercial landing page associated with the query in the database 308 can be identified.

At stage 408, the relevant commercial landing web pages are ranked. For example, the commercial landing web pages can be ranked based on a degree of relevance to the query. As another example, a commercial landing page that links to other commercial landing pages identified at stage 406 (i.e., a parent page) can be ranked higher than identified commercial landing pages that do not link to other identified commercial landing pages.

In some implementations, ranking the commercial landing web pages can include ranking ads associated with the commercial landing web pages. For example, referring to FIG. 3, the relevance server 306 can generate or access one or more ads associated with identified commercial landing web pages. The relevance server 306 can provide the ads to the ad mixer 302. The ad mixer 302 can assign rankings to the received ads. For example, the bid processor 310 can rank the ads according to bids associated with each of the ads. Ads having highest bids can be assigned the highest rankings. As another example, the relevance checker 312 can assign rankings based on geo-location information (e.g., location where the new query originated, or location of a business associated with an ad), demographic information, time stamp information, or relevance to the new query.

At stage 410, one or more ads associated with one or more highest ranking relevant commercial landing web pages are provided in response to the new query. For example, the relevance server 306 of FIG. 3 can provide ads generated using information extracted from the identified commercial landing pages to the ad mixer 302, where the provided ads are associated with commercial landing pages having the highest ranking. As another example, the query processing service 102 of FIG. 1 can provide an ad having a highest ranking score to the client device 104.

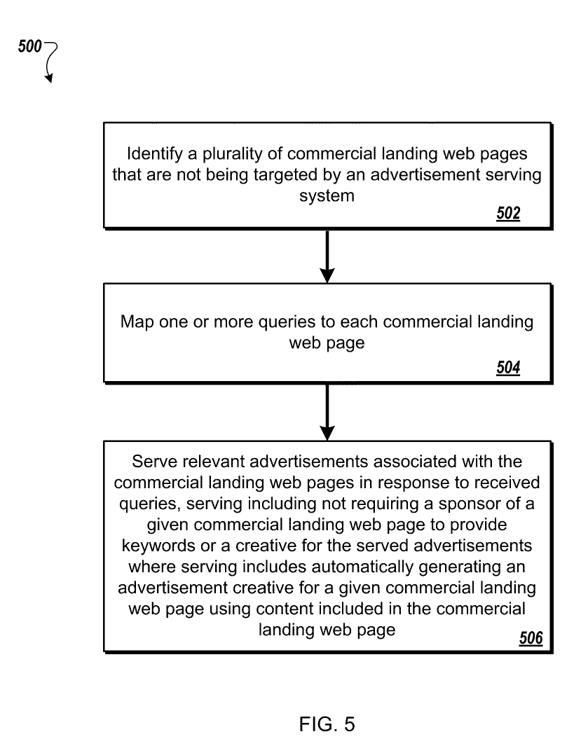

Referring now to FIG. 5, a method 500 is shown for serving relevant advertisements associated with commercial landing web pages in response to received queries. The method 500 can be performed by a system, such as the query processing service 102 shown in FIG. 3 or the system 100 shown in FIG. 1. At stage 502 a plurality of commercial landing web pages that are not being targeted by an advertisement serving system are identified. For example, an advertiser request that an advertisement serving system identify commercial landing pages associated with the advertiser that are not currently being targeted. In some implementations, the ad serving system can search one or more web sites associated with the advertiser to identify pages included in the web sites that are not currently targeted for advertising purposes. For example, a sporting goods manufacturer can have a web site that includes web pages that provide information on products sold by the sporting goods manufacturer. In some instances, the web pages can allow users to purchase the sporting goods. In some implementations, the ad serving system can identify product pages for which ads are not currently being served to end users. In some implementations, the ad serving system can determine if identified web pages are in fact associated with a purchasable product or service.

At stage 504, one or more queries are mapped to each commercial landing web page. For example, user queries received by an ad serving system or a search service associated with the ad serving system that resolve to any of the identified commercial landing web pages can be indexed in a database and associated with the commercial landing web pages to which they resolve within the database. As another example, the query processing service 102 of FIG. 3 can populate the database 308 with query/commercial landing page pairs. As another example, queries stored in the database 308 can link to keywordless creative data structures associated with commercial landing pages. In some implementations, associating a commercial landing web page with a query includes associating the query with an ad generated for the commercial landing web page or associating the query with a keywordless creative data structure for the commercial landing web page.

At stage 506, relevant advertisements associated with the commercial landing web pages are served in response to received queries. For example, referring to FIG. 1, the query processing service 102 provides relevant ads to the client device 104 for presentation to the user 108. In some implementations, serving the relevant ads includes not requiring a sponsor of a given commercial landing web page to provide keywords or a creative for the served advertisements. In some implementations, serving the relevant ads further includes automatically generating an advertisement creative for a given commercial landing web page using content included in the commercial landing web page. For example, metadata stored in a keywordless creative data structure can be used to generate an ad creative for an associated commercial landing web page as described above with reference to FIG. 3. In some implementations, the keywordless creative data structure is populated with information extracted from associated commercial landing web pages. As another example, an ad creative can be generated directly from information extracted from a commercial landing web page without a keywordless creative data structure being created for the commercial landing web page.

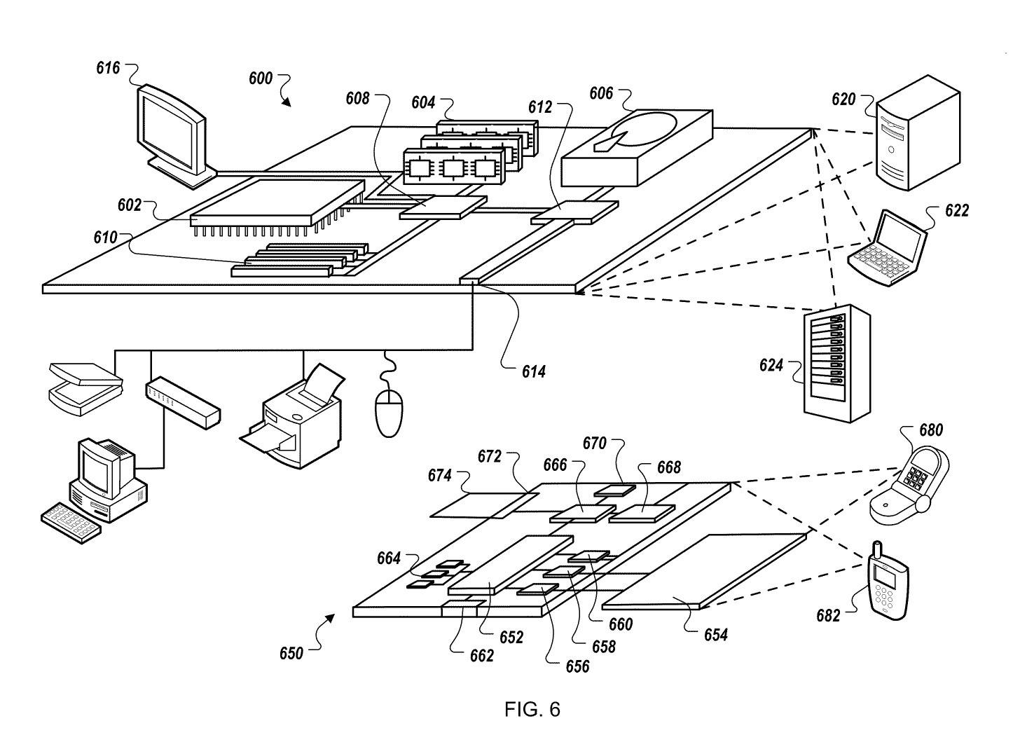

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or a memory on processor 602.

The high speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communication audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
Indexing a plurality of commercial landing web pages in a database using queries previously resolved to the commercial landing pages where each entry in the database includes at least one query and a pointer to a commercial landing web page;
Receiving a query;
Processing the query by one or more processors including identifying a relevant commercial landing web page using the query; and
Generating an advertisement creative from the relevant commercial landing web page.

2. The method of claim 1 where each entry in the database includes metadata for generating the advertisement creative.

3. The method of claim 2 where the metadata includes a title from an associated commercial landing web page.

4. The method of claim 2 where the metadata includes a title derived from large font words included in an associated commercial landing web page.

5. The method of claim 2 where the metadata includes a title derived from anchors associated with the commercial landing web page.

6. The method of claim 2 where the metadata includes segmentation data that identifies n-grams in a title associated with the commercial landing web page.

7. The method of claim 2 where the metadata includes a destination uniform resource locator (URL) associated with the commercial landing web page.

8. The method of claim 1 where each entry in the database includes a creative previously generated from an associated commercial landing web page.

9. The method of claim 1 where the pointer to a commercial landing page is of the form of metadata describing content from the commercial landing web page which is used to generate the advertisement creative.

10. The method of claim 1 where the pointer to a commercial landing page is of the form of a creative previously generated from an associated commercial landing web page.

11. The method of claim 1 where indexing includes mapping one or more queries to a commercial landing web page.

12. The method of claim 11 where mapping includes mapping plural queries to one commercial landing page.

13. The method of claim 1 where generating an advertisement creative includes extracting at least a portion of the content from the relevant commercial landing web page.

14. The method of claim 1 where generating an advertisement creative includes extracting a title from the relevant commercial landing web page.

15. A method comprising:
Mapping commercial landing web pages to one or more queries, each query being historically resolved at least once to a given commercial landing web page;
Receiving a new query;
Processing, by one or more processors, the new query including comparing the new query to the queries in the mapping to locate one or more relevant commercial landing web pages;
Ranking the relevant commercial landing web pages; and
Providing one or more ads associated with one or more highest ranking relevant commercial landing pages in response to the new query.

16. A method comprising:
Identifying a plurality of commercial landing web pages that are not being targeted by an advertisement serving system;
Mapping one or more queries to each commercial landing web page; and
Serving relevant advertisements associated with the commercial landing web pages in response to received queries, serving including not requiring a sponsor of a given commercial landing web page to provide keywords or a creative for the served advertisements where serving includes automatically generating an advertisement creative for a given commercial landing web page using content included in the commercial landing web page.
